(19) United States
(12) Patent Application Publication
(10) Pub. No.: US 2022/0229954 A1
(43) Pub. Date: Jul. 21, 2022

(54) AUTONOMOUS VEHICLE TRAFFIC SIMULATION AND ROAD NETWORK MODELING

(71) Applicant: Ford Global Technologies, LLC, Dearborn, MI (US)

(72) Inventors: Archak Mittal, Canton, MI (US); James Fishelson, Ypsilanti, MI (US); Yifan Chen, Ann Arbor, MI (US)

(73) Assignee: Ford Global Technologies, LLC, Dearborn, MI (US)

(21) Appl. No.: 17/574,240

(22) Filed: Jan. 12, 2022

Related U.S. Application Data
(60) Provisional application No. 63/139,276, filed on Jan. 19, 2021.

(51) Int. Cl. G06F 30/20

(52) U.S. Cl. CPC G06F 30/20; B60W 60/001

(57) ABSTRACT

A method for improving computational speed of a vehicle modeling processor, includes discretizing a continuous space road map by generating a first graph node associated with a first infrastructure feature and a first area and generating a second graph node associated with a second infrastructure feature and a second area. The system determines a first graph node area associated with the first graph node, determines a second graph node area associated with the second graph node, and determines a connecting link type that connects the first graph node to the second graph node, and computing a set of probabilities for nodes occupied by a vehicle agent of a plurality of vehicle agents. The system generates a simulation that models a vehicle agent driving action based on set of driving actions probabilities. Processing performance of the modeling computer is improved by omitting computations for non-occupied nodes using cellular automata rules.

### CROSS-REFERENCE TO RELATED PATENT APPLICATION(S)

This application claims the benefit of U.S. Provisional Application No. 63/139,276, filed Jan. 19, 2021, the disclosure of which is incorporated by reference as set forth in full.

### BACKGROUND

It is desirable to simulate connected and automated vehicle (CAV) traffic flow at both the vehicle and system level in a way that is flexible, rapid, accurate, scalable, and cyber secure. Current techniques simulate individual vehicle movements via their interactions with each other, allowing for the study of CAV performance early on and the assessment of their transportation impacts. Various tools are currently available for simulating vehicle behavior as CAVs integrate in general traffic with human-driven vehicles. However, there are substantial limitations with existing tools that prevent them from efficiently simulating CAVs. These tools are (i) highly detailed, parameterized models for driver behaviors; (ii) good at representing traditional vehicles and current traffic; and (iii) bad at simulating CAVs or other unknown modes, typically using either rough estimates (endogenous but inaccurate) or requiring co-simulation (exogenous).

Simulating CAV traffic flow has several unique challenges. For example, CAVs are not a single type of vehicles, and many factors will impact their performance. CAVs will act differently from human-driven vehicles, with limited real-world data to enable calibration. Even directional findings can be difficult, such as generation of reliable predictions that determine whether integration of autonomous vehicles (AVs) with human-driven vehicle traffic will increase or decrease roadway congestion. Conventional tools may also lack simulation and modeling efficiency when modeling environmental conditions such as lane closures, road grade changes, and weather conditions that can alter traffic patterns.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2A illustrates traffic simulation showing vehicle traffic and shockwave propagation using cellular automata (CA) in accordance with the present disclosure.

FIG. 2B depicts a plurality of graph nodes in a CA model in accordance with the present disclosure.

FIG. 3A illustrates an example user interface of the disclosed CA modeling system in accordance with the present disclosure.

FIGS. 3B-3D depict example road network models in accordance with embodiments of the present disclosure.

FIG. 4 depicts a flow diagram of an example method for improving computational speed of a vehicle modeling processor in accordance with the present disclosure.

FIG. 5 is an example programmatic logic for controlling a connected autonomous vehicle in accordance with the present disclosure.

FIG. 6 illustrates converting a continuous roadway map to a discretized graph node mode in accordance with embodiments of the present disclosure.

FIG. 7 depicts a graph of reward function attributes in accordance with embodiments of the present disclosure.

### DETAILED DESCRIPTION

### Overview

The systems and methods disclosed herein are configured and/or programmed to implement a discrete traffic simulation modeling approach using cellular automata (CA) logic rules, combined with real-world traffic data, to create an automatically calibrated traffic simulation as described herein.

In some embodiments, the system creates a flexible lattice network to discretize an area map of real-world roadways to model connected autonomous vehicles (CAVs) as they would operate on various types of roadways, in various traffic situations that also account for human-driven traffic. Aspects of the present disclosure describe systems that may improve fidelity and computation efficiency for CA traffic simulation computers, as they evaluate, model, and generate key performance indicator (KPI) data that measure CAVs and other vehicle traffic on real-world roadway networks. Example KPIs can include traffic throughput (vehicles per hour per lane), travel speed, fuel consumption, delay at an intersection, queue length, or other indicators of traffic flow.

A system and method comprising using a double deep neural network to create accurate CA models where there is a lack of data for autonomously driven vehicles.

A system and method comprising creating a CA based environment to emulate multiple vehicle types simultaneously. In some aspects, the vehicle types can include autonomous vehicles (AVs), human-driven vehicles, wirelessly connected vehicles, and other vehicle types as described in the following embodiments.

In some aspects, a Connected Autonomous Vehicle (CAV) micro-scale modeling system (hereafter “CAV modeling system”) may apply cellular automata (CA) techniques to import and convert traditional continuous space maps such as, for example, road and infrastructure maps, into the discretized directed graphs. In some aspects, the road and infrastructure maps can include map representations of streets, intersections, traffic signals, turning lanes, roadway direction information, and other characteristics associated with real-world infrastructure. The CAV modeling system may generate a flexible graph discretized into connected nodes. The disclosed system outputs flexible and scalable traffic simulations for CAV and human-driven vehicle traffic with flexibility that allows ease of use, and with techniques that improve the performance of computer processing devices that execute the model.

In some embodiments, the CAV modeling system applies simplified CA rule sets to accurately represent complex phenomena of human behavior, while providing great flexibility and easy modifications. The CAV modeling system is configured and/or programmed to receive real-world driver data and update the system by calibrating and training base CA driver models. The CA driver models may include micro-scale hierarchical probabilistic behavioral rules.

In another embodiment, the disclosure provides endogenous modeling of CAV driving behavior in the virtual environment. For example, the systems and methods may convert AV logic into simple CA rules with easily tunable parameters using a double-deep neural network with self-learning capabilities. In some aspects, the CAV modeling system may iteratively train AV driver models using a greedy algorithm. In other aspects, the CAV modeling system may include a user interface providing an elegant control environment that allows users to add new parameters for different vehicle types/behaviors, with control features to assign parameters for rule implementation.

In another example embodiment, the CAV modeling system generates executable instruction sets to model connected vehicles as “informed AVs” aware of the actions and kinematics of other connected vehicles, receiving this data from other connected vehicles or infrastructure nodes within their detection range. The system is configured and/or programmed to consider the modeled connected vehicles separately or combined with automation with an adjustable detection range defined by a user-selectable cellular dimension that may be associated with discretized characteristics of the modeled environment.

These and other advantages of the present disclosure are provided in greater detail herein.

### Illustrative Embodiments

The disclosure will be described more fully hereinafter with reference to the accompanying drawings, in which example embodiments of the disclosure are shown, and not intended to be limiting.

Simulating CAV traffic flow has several unique challenges. For example, CAVs are not a single type of vehicle, but rather may take various forms, have different navigational and operational capabilities. Many factors can impact their performance. Once widely adopted by the general public, CAVs will act differently from human-driven vehicles with limited real-world data to enable calibration of their operational processing. Even directional findings can be difficult, such as generation of reliable predictions that determine whether integration of AVs with human-driven vehicle traffic will increase or decrease roadway congestion.

Accordingly, Cellular Automata (CA) approaches, and particularly the approaches described herein, are well-suited to unknown landscapes and emergent phenomena which can address these issues. Conventional tools may also lack simulation and modeling efficiency when modeling environmental conditions such as lane closures, road grade changes, and weather conditions that can alter traffic patterns. Moreover, conventional CAV traffic modeling systems may not provide traffic modeling for human-driven vehicle traffic, and they have been used to model CAV traffic as well. It may be advantageous, therefore, to provide a system that can model complex CAV and human-driven traffic scenarios, without providing an overwhelming volume of calculating requirements on the processors used to run the models. Stated in a different way, a system configured and/or programmed to model CAV and human-driven vehicle traffic that improves the functionality of the computing platform is advantageous for many reasons.

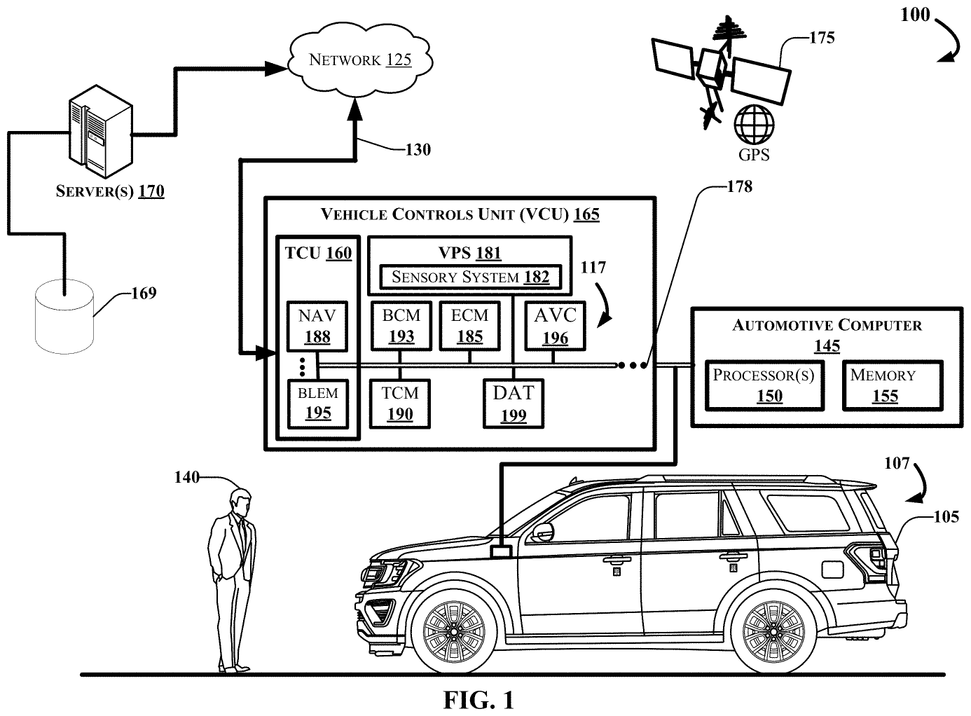

FIG. 1 depicts an example computing environment 100 that can include a vehicle 105, which may be an example of a vehicle whose operation is modeled using the disclosed system. The vehicle 105 may include an automotive computer 145, and a Vehicle Controls Unit (VCU) 165 that can include a plurality of electronic control units (ECUs) 117 disposed in communication with the automotive computer 145.

The vehicle 105 may also receive and/or be in communication with a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with one or more server(s) 170. The server(s) 170 may be part of a cloud-based computing infrastructure and may be associated with and/or include a Telematics Service Delivery Network (SDN) that provides digital data services to the vehicle 105 and other vehicles (not shown in FIG. 1) that may be part of a vehicle fleet. As used herein, the vehicle fleet may refer to related or unrelated vehicles that operate on roadways by sharing information wirelessly with one another that aids the flow of traffic and the operation of respective vehicles on the roadways.

Although illustrated as a sport utility, the vehicle 105 may take the form of another passenger or commercial automobile such as, for example, a car, a truck, a crossover vehicle, a van, a minivan, a taxi, a bus, etc., and may be configured and/or programmed to include various types of automotive drive systems. Example drive systems can include various types of internal combustion engines (ICEs) powertrains having a gasoline, diesel, or natural gas-powered combustion engine with conventional drive components such as, a transmission, a drive shaft, a differential, etc.

In another configuration, the vehicle 105 may be configured as an electric vehicle (EV). More particularly, the vehicle 105 may include a battery EV (BEV) drive system or be configured as a hybrid EV (HEV) having an independent onboard powerplant, a plug-in REV (PHEV) that includes a REV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features. A vehicle having Level-1 autonomy may include a single automated driver assistance feature, such as steering or acceleration assistance. Adaptive cruise control is one such example of a Level-1 autonomous system that includes aspects of both acceleration and steering. Level-2 autonomy in vehicles may provide driver assist technologies such as partial automation of steering and acceleration functionality, where the automated system(s) are supervised by a human driver that performs non-automated operations such as braking and other controls. In some aspects, with Level-2 autonomous features and greater, a primary user 140 may control the vehicle while the user is inside of the vehicle, or in some example embodiments, from a location remote from the vehicle but within a control zone extending up to several meters from the vehicle while it is in remote operation. Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task. Level-4 AVs can operate independently from a human driver but may still include human controls for override operation. Level-4 automation may also enable a self-driving mode to intervene responsive to a predefined conditional trigger, such as a road hazard or a system event. Level-5 AVs may include fully autonomous vehicle systems that require no human input for operation and may not include human operational driving controls. Accordingly, the CAV modeling system 107 may provide instruction sets that control some aspects of control to the vehicle 105, when the vehicle is configured as an AV.

The wireless connection(s) 130 are depicted in FIG. 1 as communicating via the one or more network(s) 125, and via one or more wireless connection(s) that can be direct connection(s) between the vehicle 105 and other devices. The wireless connection(s) 130 may include various low-energy protocols including, for example, Bluetooth®, Bluetooth® Low-Energy (BLE®), UWB, Near Field Communication (NFC), or other protocols. CAVs or connected but human-driven vehicles may also share information directly without an intervening server or distributed computing system.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the CAV modeling system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases 169). The processor(s) 150 may utilize the memory 155 to store programs in code and/or to store data for performing aspects in accordance with the disclosure. The memory 155 may be a non-transitory computer-readable memory storing a CAV program code. The CAV program code may be or include output from the CAV modeling system 107, where the system creates and improves a functional autonomous vehicle instruction set. The memory 155 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The VCU 165 may share a power bus 178 with the automotive computer 145 and may be configured and/or programmed to coordinate the data between vehicle 105 systems, connected servers (e.g., the server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Driver Assistances Technologies (DAT) controller 199, etc. The VCU 165 may further include and/or communicate with a Vehicle Perception System (VPS) 181, having connectivity with and/or control of one or more vehicle sensory system(s) 182. In some aspects, the VCU 165 may control operational aspects of the vehicle 105 from one or more instruction sets stored in computer-readable memory 155 of the automotive computer 145, including instructions generated by the CAV modeling system 107.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a BLE® Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and BLE® communication protocols by broadcasting and/or listening for broadcasts of small advertising packets and establishing connections with responsive devices that are configured according to embodiments described herein. For example, the BLEM 195 may include Generic Attribute Profile (GATT) device connectivity for client devices that respond to or initiate GATT commands and requests.

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, and/or the CAV modeling system 107, which may be operational on and/or include the server(s) 170, etc.), and may also communicate with one another without the necessity of a host computer.

The VCU 165 may control various loads directly via the bus 180 communication or implement such control in conjunction with the BCM 193. The ECUs 117 described with respect to the VCU 165 are provided for example purposes only and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers, inputs from an autonomous vehicle controller, the CAV modeling system 107, and/or via wireless signal inputs received via the wireless connection(s) 130 from other connected devices. The ECUs 117, when configured as nodes in the bus 180, may each include a central processing unit (CPU), a CAN controller, and/or a transceiver (not shown in FIG. 1).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, driver assistance systems, AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

The DAT controller 199 may provide Level-1 through Level-3 automated driving and driver assistance functionality that can include, for example, active parking assistance, trailer backup assistance, adaptive cruise control, lane keeping, and/or driver status monitoring, among other features. The DAT controller 199 may also provide aspects of user and environmental inputs usable for user authentication. Authentication features may include, for example, biometric authentication and recognition.

The DAT controller 199 can obtain input information via the sensory system(s) 182, which may include sensors disposed on the vehicle interior and/or exterior (sensors not shown in FIG. 1). The DAT controller 199 may receive the sensor information associated with driver functions, vehicle functions, and environmental inputs, and other information. The DAT controller 199 may characterize the sensor information for identification of biometric markers stored in a secure biometric data vault (not shown in FIG. 1) onboard the vehicle 105 and/or via the server(s) 170.

In other aspects, the DAT controller 199 may also be configured and/or programmed to control Level-1 and/or Level-2 driver assistance when the vehicle 105 includes Level-1 or Level-2 autonomous vehicle driving features. The DAT controller 199 may connect with and/or include a Vehicle Perception System (VPS) 181, which may include internal and external sensory systems (collectively referred to as sensory system(s) 182).

An AV controller (AVC) 196 may perform object detection, navigation, and provide navigational interactive control features for vehicle autonomous operation. The AVC 196 may be disposed in communication with and/or include the CAV modeling system 107, in accordance with embodiments described herein. For example, the AVC 196 (AVC 196) may receive one or more vehicle instruction sets for a connected autonomous vehicle, which may cause the AVC to control the vehicle 105 in one or more predetermined traffic scenarios associated with a simulation that modeled and improved vehicle 105 performance in that particular scenario. In other aspects the AVC may collect historic operational data and feed the data back to the CAV modeling system 107 to improve the machine learning algorithms operational as described in one or more embodiments.

The memory 155 may include executable instructions implementing the basic functionality of the AVC 196 and a database of locations in a geographic area.

When the vehicle 105 is configured as a Level-5 autonomous vehicle, the VPS 181 may provide situational awareness to an Autonomous Vehicle Controller (AVC) 196 for autonomous navigation. For example, the VPS 181 may include one or more proximity sensors, may include one or more Radio Detection and Ranging (RADAR or “radar”) sensor configured for detection and localization of objects using radio waves, a Light Detecting and Ranging (LiDAR or “lidar”) sensor, a vision sensor system having trajectory, obstacle detection, object classification, augmented reality, and/or other capabilities, and/or the like.

The proximity sensor(s) of the VPS 181 may alert the AVC 196 to the presence of sensed obstacles, and provide trajectory information, where the trajectory information is indicative of moving objects or people that may interact with the vehicle 105. The trajectory information may include one or more of a relative distance, a trajectory, a speed, a size approximation, a weight approximation, and/or other information that may indicate physical characteristics of a physical object or person. In other aspects, the VPS 181 may provide sensory information to other vehicles wirelessly connected with and sharing information with the vehicle 105. Such a scenario is the “connected” portion of connected autonomous vehicles as understood in the art of autonomous vehicle control.

The AVC 196 may be configured and/or programmed to aggregate information from the NAV 188, such as current position and speed, along with sensed obstacles from the proximity sensor(s) of the VPS 181 and interpret the aggregated information to compute an efficient path towards a destination such that the vehicle 105 may avoid collisions. Sensed obstacles can include other vehicles, pedestrians, animals, structures, curbs, and other random objects. In some implementations the proximity sensor(s) may be configured and/or programmed to determine the lateral dimensions of the path upon which the vehicle 105 is traveling, e.g., determining relative distance from the side of a sidewalk or curb, to help aid vehicle navigation and control to maintain precise navigation on a particular path.

In some aspects, a Connected Autonomous Vehicle (CAV) micro-scale modeling system (hereafter “CAV modeling system”) may apply cellular automata (CA) techniques to import and convert traditional continuous space maps such as, for example, road and infrastructure maps, into the discretized directed graphs. In some aspects, the road and infrastructure maps can include map representations of streets, intersections, traffic signals, turning lanes, roadway direction information, and other characteristics associated with real-world infrastructure. The CAV modeling system may generate a flexible graph discretized into connected nodes. The disclosed system outputs flexible and scalable traffic simulations for CAV and human-driven vehicle traffic with flexibility that allows ease of use, and with techniques that improve the performance of computer processing devices that execute the model.

Flexible graphs, rather than a fixed size lattice, can handle morphological spatial features such as real-world roadways, lane changes, and road curvatures. For example, along highways and roadways the spacing between individual roadway nodes may adaptively change based on actual traffic speed. In some aspects, the CAV modeling system 107 may adapt to the traffic flow condition of particular roadway portions to actively change cell (node) size to accommodate various sized vehicles. For example, semi-trailer traffic may require significantly larger grid size models than motorcycle or compact vehicle traffic.

In other aspects, it is advantageous to further scale the size of the graph nodes based on vehicle speed, where higher speed travel may benefit from greater distances between nodes.

In some embodiments, the CAV modeling system 107 may apply simplified CA rule sets that accurately represent complex phenomena of human and autonomous vehicle behavior. The CAV modeling system 107 may be programmed and/or configured to receive real-world driver data from connected vehicle systems (e.g., the AVC 196) and update the CAV modeling system 107 by calibrating and training CA driver models, which are also referred to herein as vehicle agents. The vehicle agents may include micro-scale hierarchical probabilistic behavioral rules as part of their respective instruction sets such that the vehicle agents apply the behavioral rules as they simulate real-world traffic scenarios. These scenarios may contemplate and model aspects of traffic flow that can create shockwave propagation, where one or more vehicles perform an action that progressively slows the overall flow of traffic. This is often a source of traffic congestion.

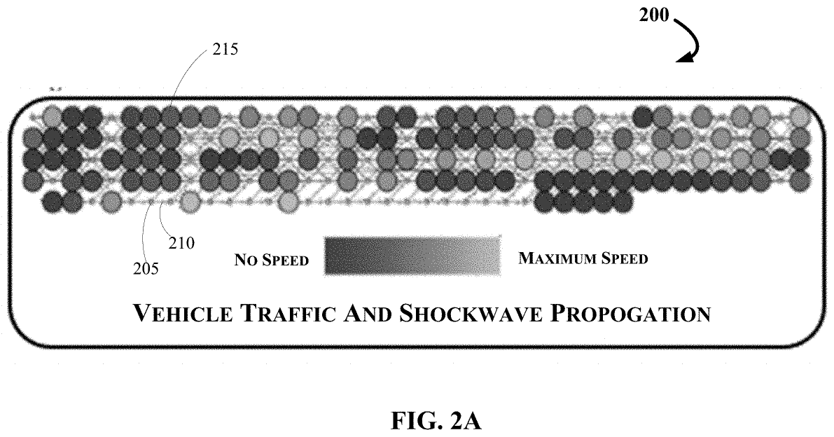

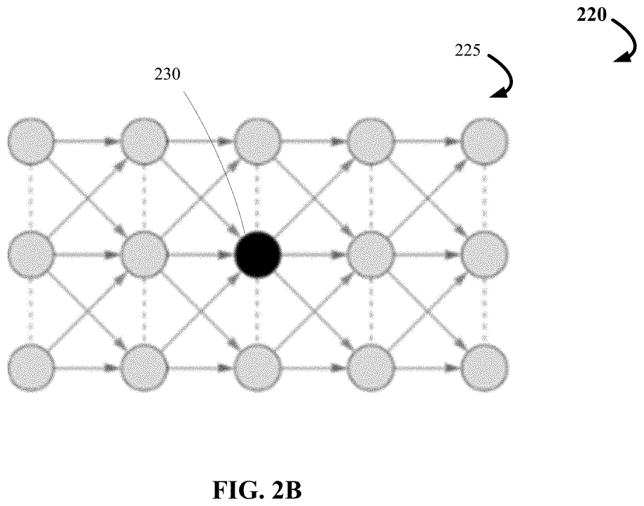

FIG. 2A illustrates a traffic simulation showing vehicle traffic and shockwave propagation using cellular automata (CA) in accordance with the present disclosure. This figure illustrates a graph of nodes 205 joined by connecting links 210. The traffic simulation illustrates one portion of a discretized continuous space road map, where each of the larger circles representing vehicle agents 215 model autonomous and human-driven vehicles operating on the roadways. The connecting links 210 may respectively include attributes that inform the modeling system of how vehicle agents (that represent actual vehicles in traffic) may behave given various traffic scenarios. As shown in FIG. 2A, the vehicle agents 215 operate in traffic scenarios with travel speed that can vary from no speed to maximum speed. The illustrated scenario of FIG. 2 shows how heavy congestion can build in real life, and such traffic may be modeled using vehicle agents operating in a virtual traffic environment (VTE).

Now considering aspects of CA in greater detail, FIG. 2B depicts a plurality of graph nodes 200 in a CA model 220, in accordance with the present disclosure. The CAV modeling system 107 may receive continuous road map data and generate road segments represented as the plurality of graph nodes 225, for example. The plurality of graph nodes are associated with one or more infrastructure features such as side roads, highway roads, turn lanes, intersections, etc.

The CAV modeling system 107 may use discrete traffic simulation modeling techniques to develop a microscopic virtual traffic environment (VTE) that simulate CAV behavior and support CAV development and virtual testing. The VTE portion shown in FIG. 2B includes virtual representations of road segments divided into cells or graph nodes 230 associated with sections of continuous road. More particularly, the graph nodes 225 represent respective sections of roadways having a user selectable dimension in length and width, such that the graph of nodes may be dense (having a respectively smaller dimension for each section of roadway) or less dense (having a respectively larger dimension for each section of roadway. Although circular in shape, each node (e.g., 230) represents a discretized roadway section of a generally rectangular shape (e.g., having a width and a length).

The graph nodes 230 may represent an infrastructure feature such has a street section, intersection, a traffic signal, a turn lane section, highway lane section, etc. Particular driving actions may be associated with respective nodes using a behavioral rule set modeling driving actions for vehicles operating on the respective node. Example driving actions can include merging, aggressive merging, moving left, aggressive moving left, moving right, aggressive moving right, overtaking, aggressive overtaking, undertaking, aggressive undertaking, drifting right, drifting left, cruising, cruising left, and cruising right, among other behaviors. For example, if a node is associated with a middle highway lane section on a straightaway, possible driving action behaviors typical for that section may include overtaking, aggressive overtaking, drifting right or left, cruising, etc.

Each of the driving actions may be represented analytically according to how likely they are to occur in each respective node. For example, in the straightaway section of a highway lane example, there may be a relatively higher probability for aggressive overtaking as compared with stopping or other actions. In one aspect, the CAV modeling system 107 may provide an interface element for setting a probability for each respective behavior.

The graph node 230 may be associated with a selectable set of independent rules that define or characterize how a vehicle would travel on that roadway portion. Modeling traffic using CA techniques differs from conventional approaches that do not divide road segments into discrete portions or cells as a basis of analysis. Instead, conventional modeling systems may generate rule sets that are ran across the entire modeled system, which may take considerable computation resources in larger more complex models. The present systems may provide flexible and readily customizable analytical tools that follow pre-defined rules that are applied only when one or more of the cells or nodes (e.g., 215) are occupied by a vehicle. FIG. 2B illustrates the graph node 230 as occupied by a vehicle, where the other nodes are not occupied. When the vehicle agent in the graph node 230 operates, the possible moves that vehicle can make include forward left, forward straight, and forward right.

Accordingly, and based on the behavioral rule set associated with the graph node 230, the CAV modeling system 107 may compute a set of probabilities of the vehicle agent driving actions. However, the CAV modeling system 107 may omit computation of the set of probabilities of vehicle agent driving actions for the rest of the plurality of graph nodes within which no vehicles operate. In that regard, the system improves the functionality of the computing system by performing computation for probabilities of vehicle agent driving actions only for occupied nodes.

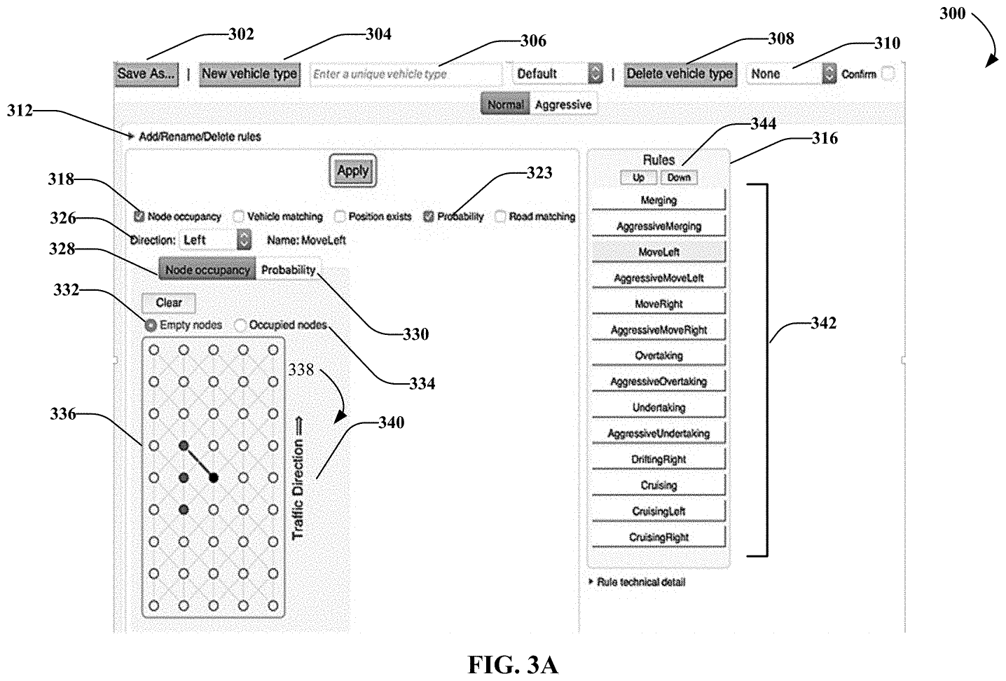

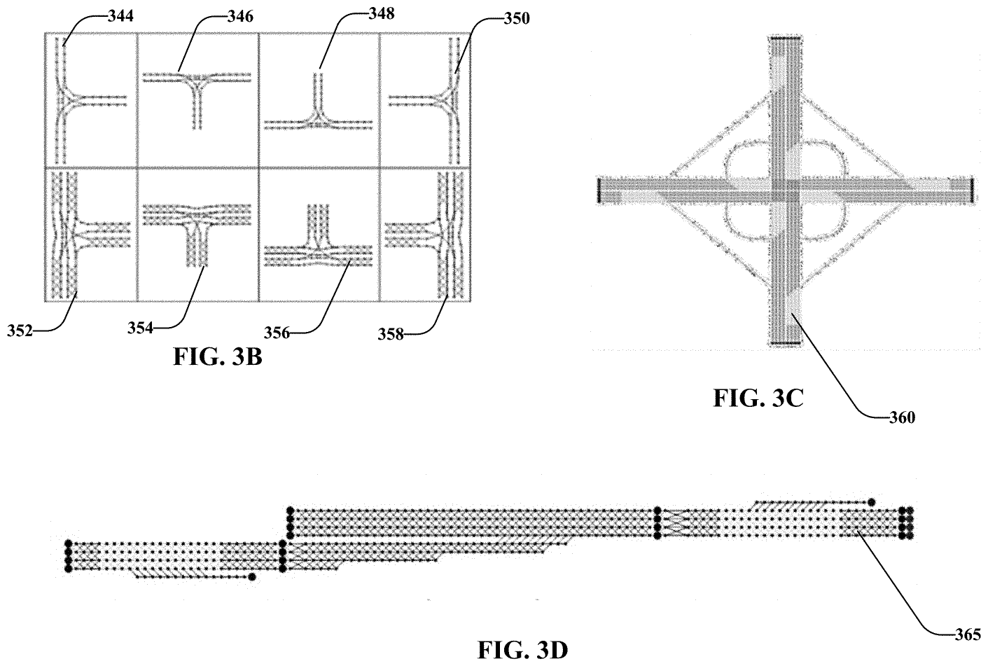

FIG. 3A illustrates an example user interface 300 for the disclosed CA modeling system, in accordance with the present disclosure. The CAV modeling system 107 may generate the user interface 300 to provide a simple and easy to use control mechanism for modeling vehicle dynamics using micro-scale hierarchical probabilistic behavioral rules translated to CA rules. The CAV modeling system 107 may calibrate driver models with real-world vehicle trajectories that emulate realistic prevailing traffic conditions.

The user interface 300 may include a control 302 for saving settings in the user interface 300. A user may use this tool based on simple visual cues that define how a vehicle should behave over various conditions.

In one example embodiment, the CAV modeling system 107 may include a control for entering a unique vehicle type 306, and a control for saving the new vehicle type 304. Example vehicle types can include cars, trucks, vans, semi-trucks, etc. The system may further include a control 308 to delete vehicle types, and a control to describe roadway conditions such as, for example, several lanes, free-flow speeds, merge lane indicators, etc.

In an add/rename/delete rules section 312, the CAV modeling system 107 may output controls for setting rules attributes associated with driving behaviors shown in rules 316. A visual representation of nodes is depicted showing vehicle travel direction 340 for a plurality of nodes 338. For example, a vehicle may travel forward, left, right, or angled forward travel from a particular node. Other directions are possible and may be indicated by the user.

The CAV modeling system 107 may output controls that allow a user (not shown in FIG. 3A) to select empty nodes 332 or occupied nodes 334 using a node occupancy control 318 or a probability control 323 and set node occupancy rules 328 or probability rules 330 for each respective rule of a set of rules 342. The CAV modeling system 107 may provide a relative order or priority for applying the rules 316 using up and down controls.

For example, the system may present a selectable behavioral rule that may be applied to one or more cells 336 in the system according to road type (e.g., for all freeway roads, side streets, etc.). In another example, the system may present a selectable behavioral rule that may be applied to vehicle types operating within any given node, or based on other attributes such as roadway travel direction, etc.

In other aspects, the CAV modeling system 107 may apply rules and respective probabilities based on roadway configurations represented as road network models that represent common roadway configurations and infrastructure features. FIGS. 3B-3D depict example road network models in accordance with embodiments of the present disclosure.

FIG. 3B depicts a plurality of infrastructure features that include intersections. For example, the infrastructure features 344-350 illustrate a two-lane interchange oriented in four configurations that merge perpendicular traffic. The direction of traffic may be selected in roadway configurations 346, 348, and 350. The four-lane interchange 352 illustrates a second set of infrastructure features with selectable traffic directions 354, 356, and 358.

FIG. 3C illustrates another selectable road network model having a cloverleaf and points of differing traffic flow 360. The points of differing traffic flow may include nodes that can contain attributes associated with vehicle type, speed, or other characteristics that change based on vehicle traffic.

FIG. 3D illustrates another highway configuration having a grid of nodes 365 that may be selectable to include unique behavioral rules as explained in FIG. 3A.

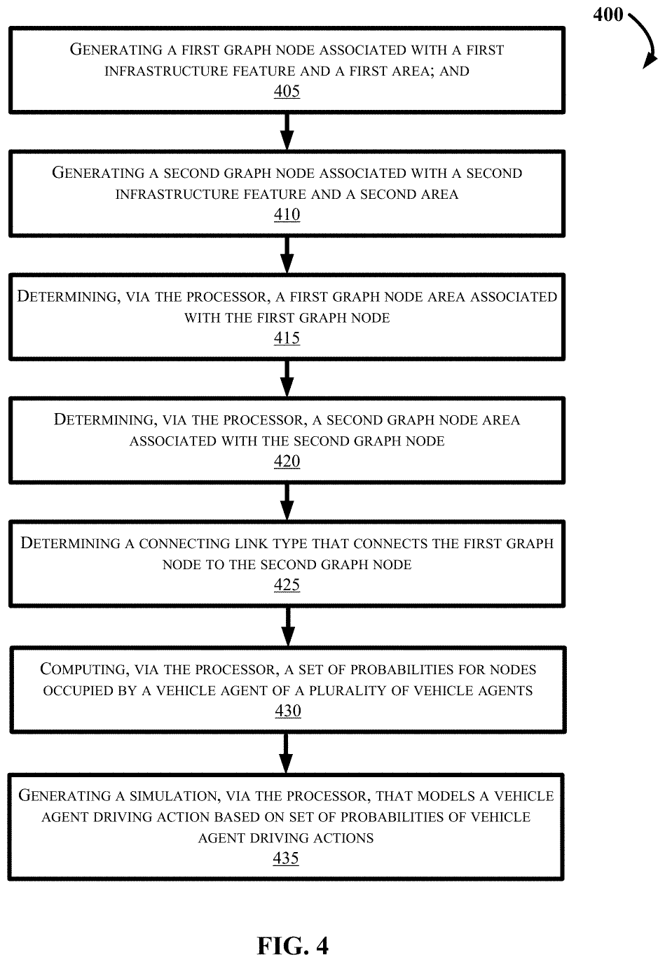

FIG. 4 is a flow diagram of an example method 400 for improving computational speed of a vehicle modeling processor, according to the present disclosure. FIG. 4 may be described with continued reference to prior figures, including FIGS. 1-3D. The following process is exemplary and not confined to the steps described hereafter. Moreover, alternative embodiments may include more or less steps that are shown or described herein and may include these steps in a different order than the order described in the following example embodiments.

Referring first to FIG. 4, at step 405, the method 400 may commence with discretizing a continuous space road map that can include generating a first graph node associated with a first infrastructure feature and a first area. The continuous space road may be or include a publicly available digital or analog road map. The CAV modeling system 107 may discretize the road map into a first plurality of graph nodes having at least one vehicle agent operating within defined boundaries of each node of the first plurality of graph nodes, and a second plurality of graph nodes having no vehicle agent operating within defined boundaries of any node of the second plurality of graph nodes. The graph node may be, for example, the graph node 230 illustrated with respect to FIG. 2B.

At step 410, the method 400 may further include generating a second graph node associated with a second infrastructure feature and a second area. This step may include determining a relative size of node to discretize the continuous road map and build the second node proximate to the first node. The first node and the second node represent contiguous sections of the discretized map, and may be connected using a connecting link (e.g., a line representing a relative association between two nodes).

At step 415, the method 400 may further include determining, via the processor, a first graph node area associated with the first graph node.

At step 420, the method 400 may further include determining, via the processor, a second graph node area associated with the second graph node based on geographic area of respective continuous map portions. This step may include evaluating a relative area proximate to the first node, and determining, based on user input, an area or bounding dimensions that define a node size.

At step 425, the method 400 may further include determining a connecting link type that connects the first graph node to the second graph node. This step may include identifying the first node and the second node and determining their relative proximity to one another.

At step 430, the method 400 may further include computing, via the processor, a set of probabilities for nodes occupied by a vehicle agent of a plurality of vehicle agents. The probabilities may refer to respective probabilities for a vehicle to perform an operation consistent with a vehicle behavior, such as overtaking another vehicle, merging left, merging right, slowing down and undertaking another vehicle, or other options.

This step may include receiving, via the processor, a user selection indicative of a selectable behavioral rule on a behavioral rules list, receiving, via the processor, a user input comprising a probability indicator associated with the selectable behavioral rule, generating a model for the vehicle agent driving action based on the probability indicator and the selectable behavioral rule, and outputting the KPI associated with the vehicle agent driving action using the model.

At step 435, the method 400 may further include generating a simulation, via the processor, that models a vehicle agent driving action based on set of probabilities of vehicle agent driving actions. This step may include computing the set of probabilities of vehicle agent driving actions for the first plurality of graph nodes and omitting computation of the set of probabilities of vehicle agent driving actions for the second plurality of graph nodes. In some aspects, modeling the vehicle agent driving action can include determining, via the processor, a behavioral rule based on a link type, and further based on a rule of a behavioral rule set; and assigning, via the processor and based on the rule, a key performance indicator (KPI) associated with vehicle agent driving action. In some aspects, behavioral rule set is user selectable to include weighted modeling rules associated with a driving action of a set of driving actions comprising merging, aggressive merging, moving left, aggressive moving left, moving right, aggressive moving right, overtaking, aggressive overtaking, undertaking, aggressive undertaking, drifting right, drifting left, cruising left, and cruising right. The vehicle agent executes a driving model instruction set that mimics driving behavior of a connected autonomous vehicle.

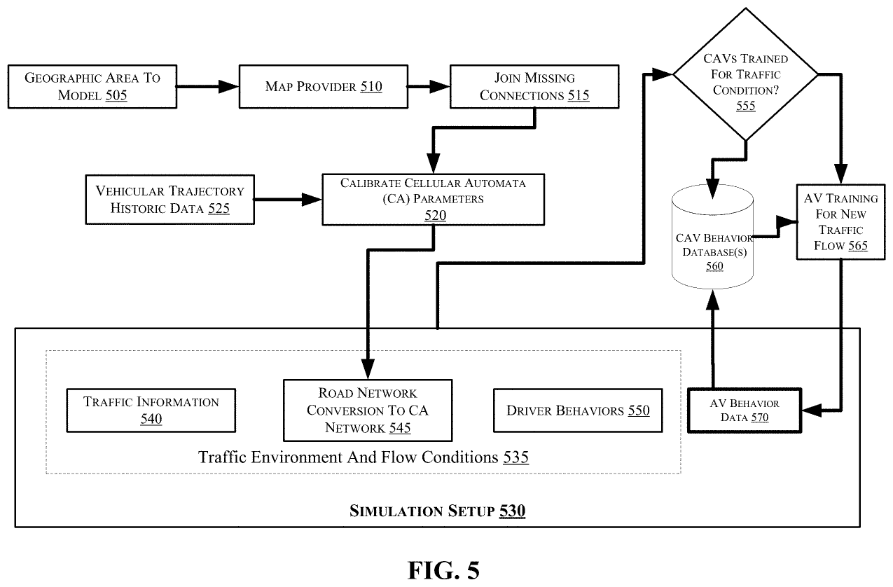

FIG. 5 is an example programmatic logic for controlling a connected autonomous vehicle in accordance with the present disclosure. According to one example embodiment, the CAV modeling system 107 may model connected vehicle behavior by generating the simulated road network environment as shown in prior figures. In some aspects, the CAV modeling system 107 may convert a continuous road network map to a graph node network. For example, as shown in block 505, the system may determine a geographic area to model and receive from a map provider (at block 510) a continuous roadway map. The CAV modeling system 107 may convert the continuous road network map to a graph node network of discretized directed graphs that represent streets, intersections, traffic signals, and other infrastructure elements into a flexible and scalable graph of roadway nodes. The graph may be flexible and scalable in that the respective size, dimensions, and associations of respective nodes may be easily changeable by the modeling system user.

Accordingly, the system may identify a third graph node of the graph node network, identify a fourth graph node of the graph node network, determine that one of the third graph node and the fourth graph node is within a threshold distance from the first graph node or the second graph node, create a second connecting link from the third graph node to the fourth graph node; and create a third connecting link from one of the first node and the second node to one of the third graph node and the fourth graph node. The system may join missing connections based on user-selectable node sizes and distances between nodes.

For example, the CAV modeling system 107 may identify a first graph node associated with a first infrastructure feature and a first area, identify a second graph node associated with a second infrastructure feature and a second area, and join missing connections between respective nodes as shown in block 515. In some aspects, the CAV modeling system 107 may create a first connecting link that connects the first graph node to the second graph node, assign, to the first connecting link, a first link type indicative of a vehicle movement on a roadway portion associated with the first graph node and the second graph node, and generate the simulated road network environment having the first link and the second link, where a vehicle agent is executable to model driving behaviors based on the first link type.

The processor may be further programmed to create the first link type by selecting from a group of link types that can include one-way travel, two-way travel, highway travel, and side road travel. In other aspects, the CAV modeling system 107 may improve processing speed of the computing processor generating the model by copying the set of link attributes from the first connecting link to the third connecting link, where the first connecting link and the second connecting link comprise the same link attributes.

The CAV modeling system 107 may model the vehicle agent by executing the instructions to determine a behavioral rule based on the first link type, and further based on a rule of a behavioral rule set, and assign, based on the rule, a key performance indicator (KPI) associated with vehicle agent driving action. In some aspects, the behavioral rule set may be user selectable to include weighted modeling rules associated with a driving action of a set of driving actions, as illustrated in FIG. 3A.

The CAV modeling system 107 may calibrate cellular automata (CA) parameters as shown in block 520 by receiving vehicular trajectory historic data 525, generating the CA parameters based on the vehicular trajectory historic data 525, and providing the CA parameters at step 545. Traffic environment and flow conditions 535 may include actual or predicted traffic information 540 and observed or predicted driver behaviors 550 that indicate relative probabilities for drivers or AVs to perform maneuvers given particular roadway conditions. The AV behavior data 570 may be used to update one or more CAV behavior database(s) 560, which may be used for training the AVs for new traffic flow conditions that not all AVs may have encountered. Stated another way, the experience of some AVs may be usable by the CAV modeling system 107 to train rules based on successful navigation of particular and unique traffic conditions. The CAV modeling system 107 may determine whether an AV is trained for that particular traffic condition at step 555, and responsive to determining that it has successfully navigated that traffic condition, the CAV modeling system 107 may either update the CAV behavior database(s) 560 or forward a revised rule set to the AV (step 565) if it has never encountered that condition with relative success or been trained to navigate the traffic condition.

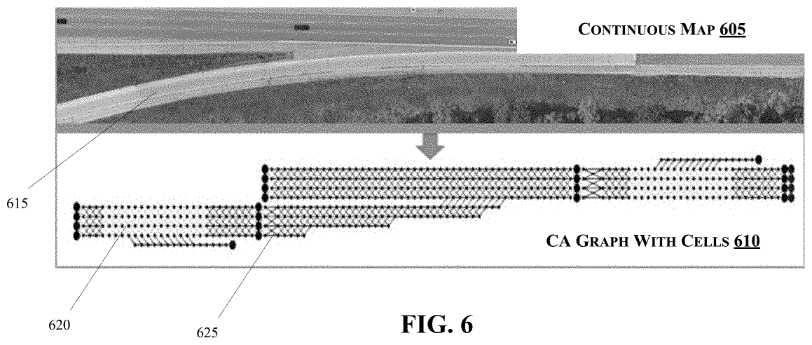

FIG. 6 illustrates converting a continuous roadway map to a discretized graph node mode in accordance with embodiments of the present disclosure. Accordingly, the CAV modeling system 107 may generate a virtual traffic environment based on a continuous space road map. This process may include modeling, via a processor, a first vehicle agent operating in the virtual traffic environment, and setting, via the processor, an adjustable detection range indicative of a communication distance for the vehicle agent to send and receive traffic information to and from a second vehicle agent operating in the virtual traffic environment. In some aspects, the first vehicle agent and the second vehicle agent may be user-selectable to model driving behavior of a connected autonomous vehicle or a human driven vehicle. Examples of one interface usable to this end were shown in FIG. 3A. The system may generate, based on the virtual traffic environment, and further based on the adjustable detection range a set of key performance indicators associated with traffic flow. The discretized grid network, as shown in prior figures, includes a plurality of nodes having a selectable graph node grid density that increases or decreases a graph node size. The system is flexible in that it may provide a mechanism for changing a graph node grid distance based on traffic density. This may provide a plurality of nodes having a selectable graph node size, or based on vehicle speed or vehicle type. The graph node size may be further based on the roadway type.

For example, as shown in FIG. 6, a continuous map 605 is depicted, where a real-world map of continuous roadway is discretized into the CA graph with cells 610. The relative space of the grid network in 610 can include a first grid density 620 associated with observed traffic at the merge ramp 615, and a second grid density 625 associated with the section of roadway closer to the main thoroughfare, where vehicles may tend to increase speed.

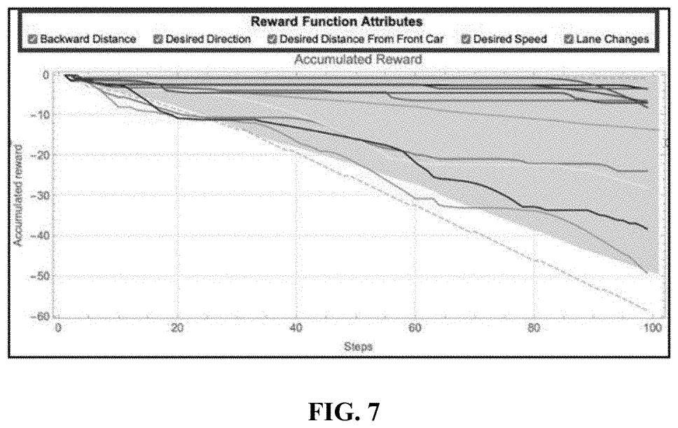

FIG. 7 depicts a graph of reward function attributes in accordance with embodiments of the present disclosure. In some aspects, the CAV modeling system 107 may utilize a reward function based on backward distance, desired direction, desired distance from a front car, a desired speed, and a count of lane changes, among other possible criteria, to train a computer model using machine learning techniques.

For example, referring again to FIG. 5, the CAV modeling system 107 may be configured and/or programmed to execute instructions to model a virtual traffic environment (simulation setup 530), and generate a simulation that models a vehicle agent driving action based on the CA graph node traffic modeling system. The CAV modeling system 107 may generate a vehicle instruction set for the connected autonomous vehicle based on the simulation as shown at box 565 (AV training for new traffic flow) and determine that the connected autonomous vehicle has encountered a predetermined traffic scenario associated with the simulation. The CAV modeling system 107 may transmit, to the connected autonomous vehicle, the vehicle instruction set, where the receiving AV may benefit from the improved functionality to navigate unique traffic situations.

In some aspects, the CAV modeling system 107 may generate the simulation using a deep neural network and determine one or more model parameters using the deep neural network. Accordingly, the system may parameterize a reward function to identify one or more vehicle maneuvers associated with navigating the vehicle agent driving action in the predetermined traffic scenario and generate the vehicle instruction set using the reward function.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method for improving computational speed of a vehicle modeling processor, comprising:
discretizing a continuous space road map comprising:
generating a first graph node associated with a first infrastructure feature and a first area; and
generating a second graph node associated with a second infrastructure feature and a second area;
determining, via the processor, a first graph node area associated with the first graph node;
determining, via the processor, a second graph node area associated with the second graph node;
determining a connecting link type that connects the first graph node to the second graph node;
computing, via the processor, a set of probabilities for nodes occupied by a vehicle agent of a plurality of vehicle agents; and
generating a simulation, via the processor, that models a vehicle agent driving action based on set of probabilities of vehicle agent driving actions.

2. The method according to claim 1, wherein the continuous space road map comprises:
a first plurality of graph nodes having at least one vehicle agent operating within defined boundaries of each node of the first plurality of graph nodes; and
a second plurality of graph nodes having no vehicle agent operating within defined boundaries of any node of the second plurality of graph nodes.

3. The method according to claim 2, wherein modeling vehicle agent driving action further comprises:
computing the set of probabilities of vehicle agent driving actions for the first plurality of graph nodes and omitting computation of the set of probabilities of vehicle agent driving actions for the second plurality of graph nodes.

4. The method according to claim 2, wherein modeling the vehicle agent driving action further comprises:
determining, via the processor, a behavioral rule based on a link type, and further based on a rule of a behavioral rule set; and
assigning, via the processor and based on the rule, a key performance indicator (KPI) associated with the vehicle agent driving action.

5. The method according to claim 4, wherein the behavioral rule set is user selectable to include weighted modeling rules associated with a driving action of a set of driving actions comprising:
merging;
aggressive merging
moving left
aggressive moving left;
moving right;
aggressive moving right;
overtaking;
aggressive overtaking;
undertaking;
aggressive undertaking;
drifting right;
drifting left;
cruising;
cruising left; and
cruising right.

6. The method according to claim 5, wherein discretizing the continuous space road map further comprises:
receiving, via the processor, a user selection indicative of a selectable behavioral rule on a behavioral rules list;
receiving, via the processor, a user input comprising a probability indicator associated with the selectable behavioral rule;
generating a model for the vehicle agent driving action based on the probability indicator and the selectable behavioral rule; and
outputting the KPI associated with the vehicle agent driving action using the model.

7. The method according to claim 1, wherein the vehicle agent executes a driving model instruction set that mimics driving behavior of a connected autonomous vehicle (CAV).

8. The method according to claim 1, wherein the first infrastructure feature and the second infrastructure feature comprises one of:
a roadway travel direction;
a freeway;
a side road;
a toll road;
an intersection; and
a number of turning lanes.

9. A system, comprising:
a processor; and
a memory for storing executable instructions, the processor programmed to execute the executable instructions to:
discretize a continuous space road map comprising:
generate a first graph node associated with a first infrastructure feature and a first area; and
generate a second graph node associated with a second infrastructure feature and a second area;
determine, via the processor, a first graph node area associated with the first graph node;
determine, via the processor, a second graph node area associated with the second graph node;
determine a connecting link type that connects the first graph node to the second graph node; and
compute, via the processor, a set of probabilities for nodes occupied by for a vehicle agent of a plurality of vehicle agents; and
generate a simulation, via the processor, that models a vehicle agent driving action based on set of probabilities of vehicle agent driving actions.

10. The system according to claim 9, wherein the continuous space road map comprises:
a first plurality of graph nodes having at least one vehicle agent operating within defined boundaries of each node of the first plurality of graph nodes; and
a second plurality of graph nodes having no vehicle agent operating within defined boundaries of any node of the second plurality of graph nodes.

11. The system according to claim 10, wherein the processor is further programmed to model the vehicle agent driving action by executing the instructions to:
compute a set of probabilities of the vehicle agent driving actions for the first plurality of graph nodes; and
omit computation of the set of probabilities for the vehicle agent driving actions for the second plurality of graph nodes.

12. The system according to claim 10, wherein the processor is further programmed to model the vehicle agent by executing the executable instructions to:
determine a behavioral rule based on a link type, and further based on a rule of a behavioral rule set; and
assign, based on the rule, a key performance indicator (KPI) associated with the vehicle agent driving action.

13. The system according to claim 12, wherein the behavioral rule set is user selectable to include weighted modeling rules associated with a driving action of a set of driving actions comprising:
merging;
aggressive merging
moving left
aggressive moving left;
moving right;
aggressive moving right;
overtaking;
aggressive overtaking;
undertaking;
aggressive undertaking;
drifting right;
drifting left;
cruising;
cruising left; and
cruising right.

14. The system according to claim 13, wherein the processor is further programmed to discretizing the continuous space road map by executing the executable instructions to:
receive a user selection indicative of a selectable behavioral rule on a behavioral rules list;
receive a user input comprising a probability indicator associated with the selectable behavioral rule;
generate a model for the vehicle agent driving action based on the probability indicator and the selectable behavioral rule; and
output the KPI associated with the vehicle agent driving action using the model.

15. The system according to claim 9, wherein the plurality of vehicle agents executes a driving model instruction set that mimics driving behavior of a connected autonomous vehicle (CAV).

16. The system according to claim 9, wherein the first infrastructure feature and the second infrastructure feature comprises one of:
a roadway travel direction;
a freeway;
a side road;
a toll road;
an intersection; and
a number of turning lanes.

17. The system according to claim 9, wherein the plurality of vehicle agents executes a driving model instruction set that mimics driving behavior of a connected human-driven vehicle.

18. A non-transitory computer-readable storage medium in a vehicle modeling computing system, the computer-readable storage medium having instructions stored thereupon which, when executed by a processor, cause the processor to:
discretize a continuous space road map to pluralities of graph nodes comprising:
a first graph node associated with a first infrastructure feature and a first area; and
a second graph node associated with a second infrastructure feature and a second area;
determine, via the processor, a first graph node area associated with the first graph node;
determine, via the processor, a second graph node area associated with the second graph node;
determine a connecting link type that connects the first graph node to the second graph node;
compute a set of probabilities for nodes occupied by a vehicle agent of a plurality of vehicle agents; and
model a vehicle agent driving action based on a set of probabilities of vehicle agent driving actions.

19. The non-transitory computer-readable storage medium according to claim 18, wherein the continuous space road map comprises:
a first plurality of graph nodes having at least one vehicle agent operating within defined boundaries of each node of the first plurality of graph nodes; and
a second plurality of graph nodes having no vehicle agent operating within defined boundaries of any node of the second plurality of graph nodes.

20. The non-transitory computer-readable storage medium according to claim 19, wherein modeling vehicle agent driving action further comprises:
computing a set of probabilities of the vehicle agent driving actions for the first plurality of graph nodes; and
omitting computation of a set of probabilities of the vehicle agent driving actions for the second plurality of graph nodes.

21-80. (canceled)
